(19) United States
(12) Patent Application Publication
(10) Pub. No.: US 2026/0227099 A1
(43) Pub. Date: Aug. 6, 2026

(54) SELENOTHERMAL ENERGY STORAGE

(71) Applicant: Government of the United States as represented by the Secretary of the Air Force, Wright-Patterson AFB, OH (US)

(72) Inventor: Jonathan Allison, Albuquerque, NM (US)

(21) Appl. No.: 19/045,874

(22) Filed: Feb. 5, 2025

(51) Int. Cl. F24S 20/64; F24S 10/95; F24S 80/20

(52) U.S. Cl. CPC F24S 20/64; F24S 10/95; F24S 80/20

(57) ABSTRACT

A thermal control system for a lunar habitation module. The system includes an absorber, the absorber having a plurality of absorber heat pipes for gathering solar energy, the absorber being positioned above a lunar regolith. A diode heat pipe can be thermally coupled to at least one of the plurality of absorber heat pipes and a downcomer heat pipe can be thermally coupled to the diode heat pipe above the lunar regolith. A network of heat capacitor heat pipes can be thermally coupled to the downcomer heat pipe below the lunar regolith and a riser heat pipe can be thermally coupled to the network of capacitor heat pipes below the lunar regolith. A variable conductance heat pipe can be thermally coupled to the riser heat pipe above the lunar regolith and thermally coupled to a penetration-free thermal interface on the outside of the lunar habitation module. A human safe heat pipe thermally coupled to the penetration-free thermal interface on the inside of the lunar habitation module and a temperature regulation module can be operationally connected to the passive thermal control system to modulate heat transfer into the lunar habitation module.

### TECHNICAL FIELD

The present disclosure relates to providing warmth to facilities in lunar environments.

### BACKGROUND

One aspect of the extremity of space environments is thermal: the sun is quite hot without filtering through earth's atmosphere and nighttime (eclipse) is very cold due to the lack of atmosphere and thermal mass, such as provided by oceans. Conventionally, eclipse thermal environments are dealt with via thermostatically controlled heaters and multilayer insulation blankets. This solution has been sufficient for eclipse durations that are commonly encountered in spaceflight today. Low earth orbit has 45-minute eclipses and geosynchronous orbit has 1.2-hour eclipses. On the lunar surface, eclipse (nighttime) is 14.75 earth days. This relatively long time presents problems for both robotic and crewed, habitations on the lunar surface.

There are currently no adequate solutions for providing electricity for warmth through the lunar night. The default solution is to use batteries to chemically store energy to provide electrical power, however this has been estimated to cost 5 kg per Watt of electricity through eclipse. This Watt/mass ratio renders this solution unattractive for crewed space habitations on the lunar surface. Nuclear power has been proposed, however regulatory, safety, and mass issues make this option unattractive as well.

There is a continuing unmet need for a way to provide warmth in lunar habitations.

There is a continuing unmet need for a way to provide warmth in lunar habitations during eclipse.

There is a continuing unmet need for a way to provide a relatively low-mass system and method for providing warmth in lunar habitations during eclipse.

### BRIEF DESCRIPTION OF THE DRAWINGS

The following detailed description of embodiments of the present disclosure can be best understood when read in conjunction with the drawings enclosed herewith:

FIG. 1 is a schematic diagram of an example embodiment of a heat-pipe based thermal control architecture for a lunar facility, which can be a crewed habitation;

FIG. 2 is a schematic diagram of an example embodiment of a heat-pipe based thermal control architecture for a facility, which can be a crewed lunar habitation during daytime;

FIG. 3 is a schematic diagram of an example embodiment of a heat-pipe based thermal control architecture for a lunar habitation during nighttime;

FIG. 4 is a schematic diagram of an example embodiment of a heat-pipe based thermal control architecture for a lunar facility, which can be a crewed habitation;

FIG. 5 is a front elevation view of a penetration-free thermal interface; and

FIG. 6 is a cross-sectional view of Section 6-6 of FIG. 5.

The embodiments set forth in the drawings are illustrative in nature and not intended to be limiting. Moreover, individual features of the drawings and the disclosure will be more fully apparent and understood in view of the detailed description.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific FIG. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

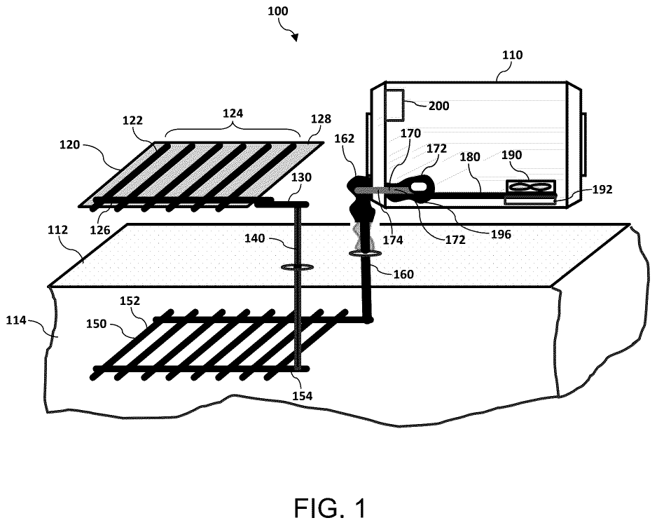

Referring to FIG. 1, there is shown an example embodiment of a system 100 for providing warmth to a habitation module 110 located on, under, or above a lunar surface 112 in which humans can be sustained through a lunar night, i.e., a lunar eclipse. The habitation module 110 can be a lunar habitation module and can be crewed or uncrewed in operation.

Portions of the system 100 are above the lunar surface 112 and portions of the system are below the lunar surface 112 in the regolith 114. The habitation module 110 can be utilized for human occupancy. In an embodiment, the habitation module 110 can rest on the lunar surface 112. In an embodiment, the habitation module 110 can be partially or fully below the lunar surface 112. In an embodiment, the habitation module 110 can be above the lunar surface, as depicted in FIG. 1, for example, on supports (not shown in FIG. 1). In an embodiment, the system 100 can be a passive thermal control system. As used herein, by “passive thermal control system” is meant a system in which the constituent components require no solid moving parts to function for their system purposes, and includes components that function without any solid internal mechanisms that physically move to operate.

In addition to the habitation module 110, the system 100 can include any of the following, as described in more detail below: one or more absorbers 120 with a network of absorber heat pipes 122; a diode heat pipe 130 joining the absorber 120 and a downcomer heat pipe 140; capacitor heat pipes 152 in a network of heat capacitor heat pipes 150 joined to the downcomer heat pipe 140 and a riser heat pipe 160; a variable conductance heat pipe 170 joined to the riser heat pipe 160 and a thermal interface outside the habitation module 110; an internal heat pipe 180 joined to a thermal interface within the habitation module 110; a cabin fan 190 and cabin heat sink 192 joined to the internal heat pipe 180 that can release and distribute the heat within the habitation module 110; and a temperature regulation module 200 operationally connected to the passive thermal control system to modulate heat transfer into the habitation module. The various components of the system 100 involve primarily, or exclusively, joined heat pipes. All joined components, including heat pipes, can be thermally coupled for heat flow management, as disclosed herein. By “thermally coupled” as used herein is meant joined to facilitate heat transfer from one component to another. In an embodiment, coupling can be achieved by joining mating surfaces, bolting, screwing, adhering, or otherwise providing for a joint heat transfer interface for efficient and/or optimal heat transfer. Thermal coupling can optionally involve a thermal interface material between coupled components to improve heat transfer from one component to another.

Referring now to FIGS. 1-3, the absorber 120 is a panel that captures solar energy 202 from the sun 204 during the lunar daytime. The absorber can be positioned in a fixed orientation, or it can be moveable to follow a trajectory of the sun as it traverses the sky throughout the lunar daytime. The absorber can be a generally flat plurality of absorber heat pipes 122 configured in a pattern, such as the generally parallel arrangement shown in FIG. 1. The absorber 120 can have a thermo-optical coating on the sun-facing surface that is optimized to absorb as much solar radiation as possible and to only reject a small amount of infrared radiation to minimize heat leaks out of the absorber 120 while also not permitting the absorber to overheat in hot survival scenarios.

In an embodiment, the absorber heat pipes 122 comprise titanium envelopes and use toluene fluid (Ti-toluene heat pipes). The absorber heat pipes 122 can be part of a honeycomb core panel designed for high temperature applications. The absorber sun-facing surface, i.e., the surface of the absorber generally facing the sun and potentially orthogonal to the suns incident light energy, can be painted with a solar selective surface (SSS), including, in an embodiment, black paint in what is known as a ‘zebra stripe’ fashion to permit the absorber face, in normal sun, to stay underneath the maximum hot survival temperature of the heat pipes and fluid. SSS is a type of coating which is very good at absorbing solar energy but very bad at emitting it as infrared radiation. SSS in space can experience 300+° C. temperatures, so zebra striping with black paint can be utilized in certain embodiments. Zebra striped black paint with an insulated back side can experience 136° C.). Zebra stripes can be close enough together that there is minimal temperature difference between the SSS and black painted regions. Zebra stripes of about 1-2″ wide can be utilized, although the dimensions and spacing can be varied as desired to ensure sufficient isothermal conditions. For example, SSS and black stripes can be of different widths to accommodate desired ratios. In an embodiment, zebra stripes can be oriented transverse to the direction that heat pipes that are locally embedded in an absorber panel.

A fixed position absorber 120 can be oriented such that it achieves the most possible insolation (solar flux) integrated throughout the lunar day. Nominally, this can be the orientation in which the sun is normal to the panel at lunar noon. At the equator, the absorber could face straight up, at higher latitudes the absorber can be mounted to point at an angle according to the latitude.

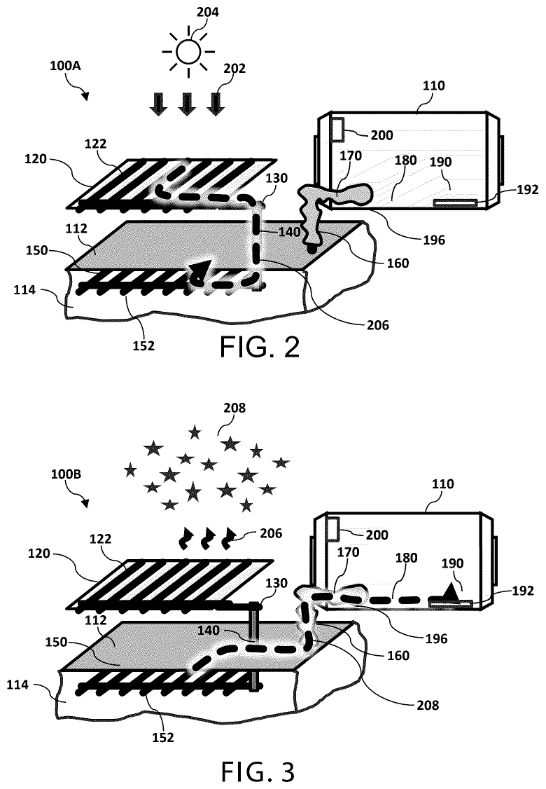

During daytime operation, indicated as system 100A in FIG. 2, the network of absorber heat pipes 122 of the absorber 120 delivers most of the heat that it absorbs from the sun to the network of capacitor heat pipes 152 of the heat capacitor 150. Heat is moved from the absorber 120 via the diode heat pipe 130 and the downcomer heat pipe 140, as indicated by the dashed arrow 206. This heat extraction causes the temperature of the absorber 120 to be cooler in operation than it would be if it were disconnected from the rest of the system (i.e. the ‘hot survival’ scenario). The maximum operating temperature of the absorber 120 is governed by the maximum useful operating temperature of the network of absorber heat pipes 122. Limiting factors in the allowable hot survival temperature can include a reduction in the heat pipe's heat transport capacity as the fluid is hotter it loses surface tension. As it reaches the fluid's critical temperature, all surface tension is lost and the heat pipe no longer operates as a heat pipe. Further, excessive pressure in the pipe poses the risk of bursting or plastic deformation. Additionally, excessive temperatures can cause excessively fast corrosion. Further, the pipes' performance can be affected by fluid decomposition temperature. This also governs how high of temperature the heat capacitor can contain which sizes the heat capacitor and thus the system mass. In an embodiment, the network of absorber heat pipes 122 can be Ti-toluene heat pipes. It is believed that Ti-toluene heat pipes can operate as hot as 280 C.

Diode heat pipes can thermally function as a one-way conductor of heat as an electronic diode functions as a one-way conductor of electricity and can be used when it is desired to facilitate heat flow in only one direction. In the system of FIG. 1, and as indicated in the daytime operation as system 100A of FIG. 2, the diode heat pipe 130 permits flow in the direction of arrow 206 when heated by the sun. However, as indicated in the nighttime operation as system 100B of FIG. 3, the diode heat pipe 130 hinders or prevents heat flow in the opposite direction. Thus, heat 202 from the sun 204 absorbed by the absorber 120 during the lunar day flows to the diode heat pipe 130, and when the evaporator is hotter than the condenser, heat flows through the diode heat pipe 130 in the direction of arrow 206. But during lunar night 208 when the absorber radiates heat 206 to space, as shown in FIG. 3, and when the diode heat pipe 130 condenser is hotter than the evaporator, heat is hindered or blocked from flowing back into the absorber 120.

There are two basic types of diode heat pipes that can be used for the diode heat pipe 130, vapor (or gas) trap diodes and liquid trap diodes. A vapor trap diode uses a non-condensable gas in a gas reservoir at the condenser end of the diode heat pipe 130. A non-condensable gas is a gas that does not condense into a liquid under the operating temperature of the heat pipe. During normal operation, the diode heat pipe 130 functions very similar to a variable conductance heat pipe. The gas reservoir at the condenser end with non-condensable gas that blocks parts of the condenser depending on the thermal load. During conditions for reverse operation the non-condensable gas moves to the opposite end of the heat pipe and blocks off what would be the condensing end, effectively shutting off most or all heat flow in that direction in the heat pipe.

A liquid trap diode heat pipe wicked reservoir at the evaporator end of the diode heat pipe 130. The reservoir wick does not communicate with heat pipe wick. In normal operation functions like constant conduction heat pipe, that is, liquid evaporates at the hot end and condenses at cold end and returns to hot end via the heat pipe wick. However, in the reverse direction, liquid evaporates at the hot side and condenses in the reservoir and becomes trapped in the separate reservoir and heat pipe wick traps the condensate in the reservoir, preventing it from returning to the hot end, effectively shutting off the heat pipe. When prograde heat flow resumes, the fluid in the reservoir is evaporated out and the vapor migrates to fill the rest of the heat pipe, allowing nominal, prograde heat transfer to resume

The diode heat pipe 130 can be oriented in such a way that it is orthogonal to the gravitational vector. In an embodiment, the condenser portion of the diode heat pipe 130 can be elevated relative to the evaporator portion. In an embodiment, the diode heat pipe 130 allows heat to flow in one direction (from the nominal evaporator to the nominal condenser) but if temperature gradients would ordinarily result in retrograde heat flow (from the nominal condenser to the nominal evaporator) then the diode heat pipe 130 shuts down its fluid convection behavior and only heat conduction through the diode heat pipe 130 envelope is possible. For this reason, the diode heat pipe 130 envelope can be made of materials with relatively low thermal conductivity, such as stainless steel and/or titanium. Also, relatively longer diode heat pipes 130 can be more beneficial than relatively shorter diode heat pipes 130 to aid in inhibiting retrograde heat transfer. In this application, the diode heat pipe 130 permits heat flow from the absorber to the heat capacitor but inhibits it in the opposite direction. In this way, heat can be collected from the absorber in the daytime but not leaked out of the heat capacitor via the absorber during nighttime.

In an embodiment, the diode heat pipe 130 can be a Ti-toluene heat pipe. Toluene as the fluid permits the diode heat pipe 130 to operate at the high operating temperatures while the titanium envelope provides thermal conduction isolation due to its relatively low thermal conductivity. In an embodiment, the length of the adiabatic section of the diode heat pipe 130 can be sufficient to keep heat leaks manageably low during lunar nighttime. The diode heat pipe 130 can also include a gas-charge for freeze/thaw management.

The thermal coupling between heat pipes of the system can be accomplished via typical heat pipe mounting materials and processes. Such materials and processes can include integral flanges on the sides of heat pipes, where flanges on faying heat pipes are tightly torqued together and, optionally, a thermal interface material (TIM) is mounted between the two heat pipe connections. In an embodiment, some of the heat pipe joints can be transported uncoupled and be assembled on the lunar surface in order to keep stowed volumes reasonable.

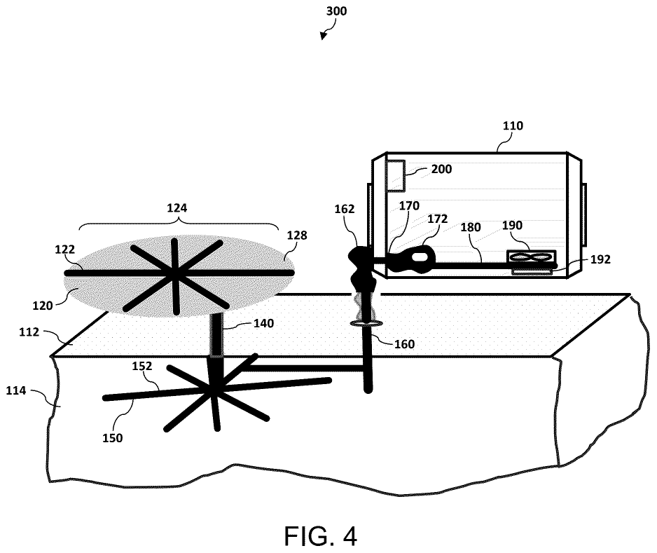

The absorber 120 may have any of various overall shapes, including rectangular as shown in FIG. 1, or disk-shaped, as shown in FIG. 4. If rectangular-shaped, then a rectangular array 124 of generally parallel absorber heat pipes 122 can pick up the heat and deliver it to one or more header heat pipes 126 (one is indicated in FIG. 1). If more than one header heat pipe 126 is used, it can be in the form of a second array of header heat pipes 126 that are co-located together for ease of transition to the next heat pipe in the system 100. Multiple header heat pipes 126 can be used for redundancy as well as providing sufficient heat transport capacity.

If the absorber 120 is disk-shaped, as shown in FIG. 4, then the absorber heat pipes 122 can be oriented in a radial array 124, in which all the absorber heat pipes 122 converge in the middle where heat is removed from the absorber 120, without the need for a header heat pipe. A rectangular-shaped absorber 120 can enable optimal heat pipe spacing which offers a mass savings, but also incurs the need for header heat pipes which involves more mass. A disk-shaped absorber 120 can have different, even opposite, advantages. In embodiments, a rectangular-shaped absorber 120 can be used for larger absorbers and a disk-shaped absorber 120 can be used for smaller absorbers. In an embodiment, larger systems can use multiple absorbers operating in parallel. Additionally, other considerations such as stowed stay-in-zones might be the deciding factor in choosing between rectangular and disk-shaped absorbers 120.

In an embodiment, thermal insulation 128 can be disposed on the backside (lunar surface side) of the absorber 120 to ensure that as much absorbed heat as possible from the absorber can be made available to the network of heat capacitor heat pipes 150. Thermal insulation 128 can take the form of either a multilayer insulation blanket or a low emissivity surface material, such as a vapor-deposited aluminum film. A multilayer insulation blanket embodiment of thermal insulation 128 can consist of lightweight reflective films assembled in many thin layers. These layers can be made of polyimide and/or polyester films and can include from 5 to 30 layers that are vapor deposited with 99.99% aluminum, on one or both sides. A multilayer insulation blanket can include a spacer material and metallized film that has been perforated. Multilayer insulation blanket films assist in the material's heat management by reducing incident energy with each successive layer. A multilayer insulation blanket has the advantage of minimizing the impact of lunar dust collecting on components and affecting its emissivity.

The diode heat pipe 130 is thermally coupled to the downcomer heat pipe 140. The downcomer heat pipe can be an oscillating heat pipe or a loop heat pipe. An oscillating heat pipe offers greater simplicity as well as low cost and reliability relative to a loop heat pipe. Oscillating heat pipes, also known as pulsating heat pipes, have serpentine channels that contain the saturated fluid in discrete droplets of liquid that are randomly interspersed between pockets of vapor. Energy absorbed in the ‘heat in’ region, causes liquid droplets there to evaporate and become vapor. Likewise, the vapor condenses in regions where energy is removed, i.e., ‘heat out’ areas. These processes generate local pressure variations that cause the liquid droplets and vapor pockets to move—thereby bringing liquid into the heated regions and vapor into the cooled regions. The random distribution of liquid and vapor droplets/pockets within the serpentine path create local fluctuations in pressures, in space and time, leading to random oscillatory flow within the oscillating heat pipe. The downcomer can also be a Ti-toluene heat pipe.

The downcomer heat pipe 140 is thermally coupled to the network of heat capacitor heat pipes 150. The downcomer heat pipe 140 can attach to the network of heat capacitor heat pipes 150 via a heat capacitor header 154 which can be thermally coupled to heat capacitor heat pipes 152. The heat capacitor heat pipes 152 can be variable or constant conductance heat pipes. In an embodiment, the heat capacitor heat pipes 152 can include gas charges to ensure that the heat capacitor heat pipes 152 are not damaged if a freeze/thaw event should occur, such as during the lunar surface assembly and installation process. A gas charge in a heat pipe refers to a relatively small amount of non-condensable gas, like helium or argon, intentionally added to the system, usually in a dedicated reservoir, which allows for the control of the heat pipe's heat transfer capacity by adjusting the effective condenser area such that the gas volume can be manipulated, for example, by the temperature regulation module 200, to regulate heat transfer depending on the operating conditions. The heat capacitor heat pipes 152 may be arranged in a rectangle with headers and spreaders or radially, as described above for the disk-shaped absorber 120.

The network of heat capacitor heat pipes 150 can be larger in area than the absorber 120. In an embodiment, a disk-shaped absorber 120 and rectangular-shaped network of heat capacitor heat pipes 150 can be used. In an embodiment, the network of heat capacitor heat pipes 150 can be arranged in such a way that the Fourier number, Fo, is from about 1 to about 3, and can be about 2. The Fourier number is a nondimensional number that measures how quickly heat can diffuse through the regolith relative to the amount of time available to store heat. In an embodiment, a value of Fo between 1 and 3 can be achieved with the capacitor heat pipes 152 in the network of heat capacitor heat pipes 150 being spaced in generally parallel relationship from about 5 inches to about 9 inches center-to-center spacing. Due to the variation in thermal conductivity of lunar regolith as a function of lunar locale, the optimal heat pipe spacing can be altered or modified based on local system requirements. For example, in lunar regolith with very low thermal conductivity, modifications in the form of thermal fins on the capacitor heat pipes 152 may improve system efficiency.

The heat capacitor heat pipes 152 may be laid out in a single layer buried in the regolith, or in multiple layers. If multiple layers are used, then the interlayer spacing can be about the same as that of spacing of heat pipes in the heat pipe network. The network of heat capacitor heat pipes 150 can be buried from about one foot to about five feet underground. A sufficient depth depends upon the thermal conductivity of the regolith. More thermally conductive regolith may require more deeply buried heat pipes to mitigate heat leaks from the top surface of the network of heat capacitor heat pipes 150. The system 100 can utilize a single layer or multiple layers of heat capacitor heat pipes 152 depending upon site specifics such as regolith thermal conductivity and hardness of the regolith, in addition to mission capabilities such as excavation tools' capability.

The heat capacitor function of the system 100 is provided by the regolith which can be used for energy storage. The Biot number is a measure of how well heat conducts through the regolith vs how well it moves through the rest of the system 100. A system 100 with a low Biot number would tend to have all the regolith at the same temperature. However, the relatively low thermal conductivity of the regolith means that the Biot number is practically infinite, which means that there is essentially zero temperature difference through the rest of the system 100 in comparison to the temperature differential throughout the regolith in the heat capacitor. This means that the system 100 heat capacitor has a very high ‘time-to-access’, meaning that it would not be an effective means of absorbing a highly pulsed energy source such as a high-power laser or high-power radar. However, the system 100 can gather heat over a 2-week period, which is a long time relative to the thermal time constant of typical spacecraft (or, indeed, most energy storage systems in any field), and is sufficiently long relative to the time constant of system 100 requirements. Another nondimensional number, the Nondimensional Temperature of the system, characterizes how close the temperature of the most remote part of the heat capacitor, at the end of a lunar day or night, is relative to the temperature of the buried heat pipes. In an embodiment, this number can be close to the ideal, meaning that nearly all the heat in the heat capacitor can be extracted over the course of the 2 weeklong lunar night and that the heat capacitor can be driven to nearly full capacity by the end of the 2 weeklong lunar day. In summary, the system heat capacitor has a very slow response time, but the duration of the charge/discharge cycles is even longer than the response time, so the system heat capacitor can function without taking extreme efforts in the heat capacitor design. In an embodiment, the system 100 operates in the absence of any additional insulation added to, in, or on top of the regolith; the regolith functions as its own insulator, and the buried heat pipes are insulated solely by regolith.

It is believed that in a relatively high thermal conductivity regolith the system does not require heat transfer enhancements (fins) on the heat capacitor heat pipes 152 to sink/extract heat from the heat capacitor but it also will tend to have higher heat leak out the sides of the heat capacitor into the adjacent natural regolith. The opposite is believed true for relatively low thermal conductivity regolith. In general, the thermal conductivity of regolith is relatively low. Although it does vary by several orders of magnitude by location, even the higher end of its thermal conductivity is considered to be a thermal insulator in comparison to other materials. The relatively low thermal conductivity of regolith is an enabling aspect of the system 100. If regolith had a very high thermal conductivity, say like that of copper, then it would be exceedingly easy to insert/extract heat from the heat capacitor, but all the heat would leak out just as quickly as it could be put in. The low thermal conductivity of the regolith permits the system 100 to provide a sort of ‘impedance match’ between the time constant of the heat capacitor's heat leak and the lunar cycle.

During lunar nighttime the absorber can encounter temperatures as low as −170° C. It is believed that there are no heat pipe fluids available that have a liquid range spanning from −170° C. to well over +100° C. As a result, the absorber heat pipes 122 can be designed for freezability by providing a suitable non-condensable gas charge in the heat pipes 122. The non-condensable gas, like helium or argon, takes up a small volume at normal operating temperatures, but a large volume as temperatures approach the freezing point. At the freezing point there is theoretically no vapor pressure and thus the internals of the heat pipe are filled with only freezing liquid/frozen solid and non-condensable gas in the vapor space. This ensures that the liquid remains in the wick of the heat pipes 122, as it should, throughout the entire freeze/thaw cycle.

In an embodiment, the system 100 operates at higher temperatures than the surrounding natural regolith. At the beginning of lunar night, the heat capacitor can be about 280° C., at the end of the lunar night it can be about 100° C. if heat product for boiling water is to be delivered, or about 50° C. if only warm water or heated air is to be delivered. In an embodiment, a multilayer insulation blanket can be positioned over the upper surface of the heat capacitor to limit heat leak out the top of the heat capacitor. In an embodiment, a multilayer insulation blanket can be spread over at least a portion of the lunar surface above at least one of the heat capacitor heat pipes 152 in the region of the of the network of heat capacitor heat pipes 150.

Referring again to FIG. 1, one or more riser heat pipes 160 can be thermally coupled to the network of heat capacitor heat pipes 150 to extract heat out of the heat capacitor during lunar night. The riser heat pipe 160 can be oriented generally vertically, that is, generally orthogonal to lunar surface 112. The riser heat pipe 160 can be, or act as, a thermosyphon, that is a wickless heat pipe that returns the liquid fluid to the evaporator via gravity. A thermosyphon is simple, and thus reliable, and is well suited to function in a gravitational orientation. The thermosyphon can be designed to satisfy similar freeze/thaw capability and operating temperatures as the previously mentioned heat pipes, thus the riser heat pipe 160 can be a Ti-toluene heat pipe.

The riser heat pipe 160 is thermally coupled to a variable conductance heat pipe 170 that can deliver heat to the habitation module 110. The riser heat pipe 160, and the portion of the variable conductance heat pipe 170 outside of the habitation module 110 can be enclosed in insulation 162 to minimize heat leak in and out of otherwise exposed portions of heat pipes. In an embodiment, the insulation 162 can be a multilayer insulation blanket wrapped around exposed heat pipes.

The variable conductance heat pipe 170 provides the ability to regulate and even shutdown heat flow into and/or out of the habitation module 110. The variable conductance heat pipe 170 can be a thermostatic variable conductance heat pipe that regulates heat into habitation module 110 during lunar night. During lunar day, the habitation module 110 does not require much (or possibly any) warming heat and thus the variable conductance heat pipe can be shut off. During the lunar night, the heat capacitor's temperature drops throughout the lunar night, which means that the variable conductance heat pipe's 170 conductance can gradually increase. The variable conductance heat pipe 170 design can be according to standard known configurations, with thermostatic capability to deliver sufficient turndown and shutoff capability to ensure that sufficient setpoint precision can be achieved in all operational environments as well as providing sufficiently rapid response times to setpoint changes. The variable conductance heat pipe 170 can include a relatively large bottle 172, an envelope made of low thermal conductivity material, a relatively long adiabatic section 174, a relatively long condenser section, and a control scheme with control authority. The control scheme with control authority can include as part of the temperature regulation module 200 with thermal control feedback loop consisting of an adjustable setpoint that can be set by the inhabitants of the habitation module 110 or by mission control that adjusts the heater power on the bottle of the variable conductance heat pipe to achieve a desired setpoint temperature. In an embodiment, the control system is computer-controlled and provides options to adjust what the setpoint temperature is, which sensors are taken into account to determine the measurand, control algorithm options, and modes for handling perceived failure events, among other things.

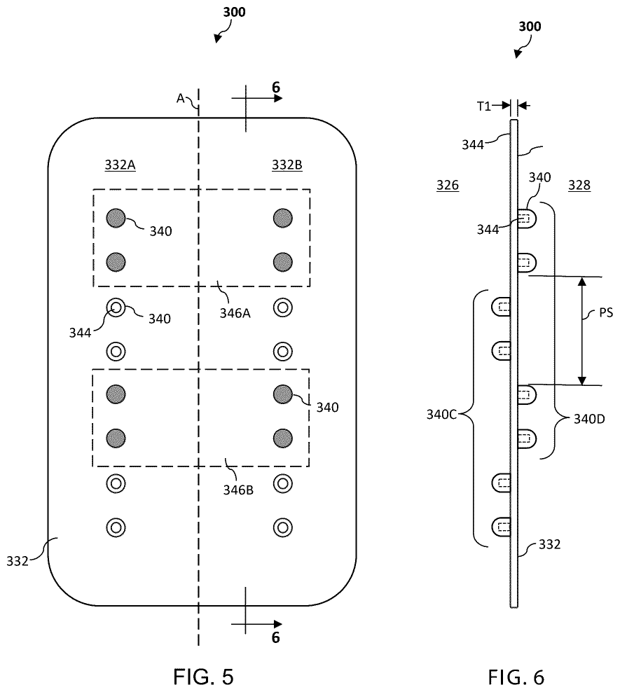

The variable conductance heat pipe 170 is thermally coupled to heat pipes inside the habitation module 110 via a penetration-free thermal interface 196 at a portion of the outer surface of the habitation module 110. Penetration-free thermal interfaces are described in detail in co-pending, co-owned U.S. Ser. No. 19/045,139 filed Feb. 4, 2025, entitled Penetration-Free Heat Transfer System, which is hereby herein by reference. Referring now to FIGS. 5 and 6, there is shown a representative embodiment of penetration-free thermal interface 300 that can b the penetration-free thermal interface 196 of FIGS. 1-3. The penetration-free thermal interface 300 can be located on any portion of the habitation module 110 that serves as a thermal barrier 332 between the outside 326 and the inside 328 of the habitation module 110. In an embodiment, the thermal barrier 332 can be portions of the sides of habitation module 110, and can exhibit corresponding surface properties, such as thickness and curvature. The thermal barrier 332 can be a portion of an outer wall, skin, or panel of the habitation module 110. In an embodiment, the thickness T1 of the thermal barrier 332 can be generally equal to, less than, or greater than, the thickness of the outer wall or outer panel of the habitation module 110.

The penetration-free thermal interface 300 permits the variable conductance heat pipe 170 external to the habitation module 110 to use a heat pipe fluid that is suited to extreme environmental temperature exposure while the internal heat pipe 180 located in the habitation module 110 can use a heat pipe fluid that is safe for human contact, in the event of heat pipe failure and exposure to the fluid. It is believed that providing the capability of wide temperature operation range and human safety cannot be achieved in the same heat pipe fluid.

An axis A can generally divide the thermal barrier 332 in the location of heat transfer into two portions. In the embodiment shown the two portions are symmetric halves. On a first half 332A there is a first row of protrusions having a plurality of protrusions 340 generally equally spaced in a line parallel to the system central axis A. Likewise, on a second half 332B there is a second row of protrusions having a plurality of protrusions 340 generally equally spaced in a line parallel to the system central axis A. In general, it is not necessary that the protrusions 340 be in rows or otherwise in an ordered pattern. All that is necessary is that at least some of the corresponding holes in the flanges of the heat pipes line up with the protrusions so that fasteners, e.g., bolts or screws, can be disposed through flanges of heat pipes and fastened to the protrusions via, e.g., internal threads. Any suitable fasteners can be utilized, including blind rivets, quick disconnect fasteners, pressure connections, quarter-turn connections, weldments, as well as glues, adhesives, and magnetic connections.

As shown in FIG. 6, a first portion 340C of the protrusions 340 extend out of the plane of the thermal barrier on the outside 326 of the thermal barrier 332, and a second portion 340D of the protrusions 340 extend out of the plane of the thermal barrier on the inside 328 of the thermal barrier 332. In general, the first portion 340C can have the same number, size, and spacing of protrusions 340 as exist on the second portion 340D. However, any number, spacing and pattern of protrusions can be employed as desired for heat conductive requirements of a heat transfer system.

As shown in FIGS. 5 and 6, the protrusions 340 can be configured as bosses formed on or in the thermal barrier with an interior defining a fastener-receiving opening 344, which can be a blind hole, and which can be internally threaded for receiving threaded fasteners. In the illustrated embodiment, the first portion 340C of protrusions 340 serve as attachment locations for a first heat pipe and the second portion 340D of protrusions 340 can serve as attachment locations for a second heat pipe.

The first portion 340C of protrusions 340 and the second portion 340D of protrusions 340 can each be patterned and spaced to accommodate the flanges of the heat pipes. For example, referring to the second portion 340D of protrusions 340, as indicated by the dashed rectangles in FIG. 5, the protrusions 340 are grouped and spaced to accommodate the flanges of the heat pipes. As shown, a first group 346A of protrusions 340 can be spaced in a group suitable for receiving fasteners for a first flange of a heat pipe and a second group 346B of protrusions 340 can be spaced in a group suitable for receiving fasteners for a second flange of a heat pipe (as discussed more fully below). In general, any number of protrusions and any number of groups of protrusions can be employed. However, for a given number and pattern of protrusions, the groups of protrusions can be spaced a protrusion distance PS apart, as indicated in FIG. 6 for groups 346A and 346B. The separation distance PS can accommodate the flanges of the heat pipes mounted to the thermal barrier. In general, the flanges of the heat pipes are “nested” between groups of protrusions in the relatively planar portions of the thermal barrier.

Referring again to FIG. 1, inside the habitation module 110 at least one human-safe heat pipe 180 picks up the heat and releases it into the habitation module 110. In an embodiment, a finned fan air heat sink can aid in warming the habitation module 110 to a setpoint temperature. A human-safe heat pipe is a heat pipe in which the materials, including the working fluid are safe for use around humans, particularly in a malfunction in which humans are exposed to the working fluid. In one embodiment, the human-safe heat pipe 124 can be comprised of an extruded grooved aluminum envelope with n-Perfluorohexane (nPFH) as the working fluid. The aluminum envelope can utilize reentrant (Omega-shaped) grooves to provide sufficient static wicking height while providing the best possible heat transport capacity. In another embodiment, the human-safe heat pipe 124 can be comprised of a copper envelope with water as the fluid and a gas-load to aid in controlled freeze/thaw conditions. Any of the exemplary heat pipes utilized can optionally include an evacuated dump tank at one end of the heat pipe with a rupture disk separating the dump tank from the active portion of the heat pipe. In the anomalous event that the heat pipe overpressures, the burst disk can rupture to provide additional volume to the heat pipe to prevent a dangerous rupture which could harm people nearby.

A plurality of human-safe heat pipes 180 can be utilized, and each can be included for dedicated thermal functions and purposes. A heat sink 192 and/or a cabin fan 190 can be thermally coupled to the human-safe heat pipe 180 to manage and/or distribute warmed air. The cabin fan 190 can be any of known cabin fans suitable for part of a ventilation system in spacecraft. The heat sink 192 can be any of known suitable heat sinks and can be a heat sink thermally coupled to the human-safe heat pipe 180. The fan speed and the properties of the heat sink can be adjustable to increase response times of the habitation module 110 air temperature to changes in temperature setpoint(s). In general, penetration-free thermal interfaces 132 permit thermal heat transfer across an interface, such as the pressurized cabin wall, without potential pressurization/air supply failure due to penetrations in the cabin wall.

In embodiments of the system 100, various heat pipe configurations can be utilized for any of the heat pipes disclosed herein, depending on design needs or requirements. For example, in embodiments, Ti-toluene heat pipes can be the default approach, however toluene has relatively poor thermal transport capacity as a heat pipe fluid. Stainless steel is also an alternative to titanium but has similar pros and cons, i.e., relatively high strength and stiffness and poor thermal conductivity. Note that thermal conductivity is a two-edged sword—low thermal conductivity means larger temperature drops across a given heat pipe interface but also means less heat leak when the heat pipe is intended not to transport heat. Water heat pipes may be appropriate in some system designs, but water's freeze-expansion behavior can pose too great a risk in context of the capability of other heat pipe options. Heat pipes made of aluminum (and with compatible fluids such as ammonia, methylamine, or pentane) are believed generally to not have a sufficiently high service temperature. Other combinations such as hastelloy-TiCl4 have high service temperatures and are contemplated for the system 100. Ti-naphthalene also has high service temperature but naphthalene's melt temperature of 80° C. is considered excessively high for use, at least in the heat capacitor heat pipes. At the highest operating temperature range, Ti-cesium can be utilized due to its high heat transport capacity. However, cesium is relatively heavy, hazardous, and also melts just above room temperature. Accordingly, Ti-toluene makes the most sense and Ti-cesium could be considered for systems 100 requiring different performance.

In embodiments of the system 100, absorber 120 orientation can be dictated by the latitude placement of the system 100 to maximize solar exposure throughout lunar day. In practice this can mean that equatorial locations can have upward facing absorbers, polar locations should have sideward facing absorbers, and mid-latitude locations should have angled absorbers. Further, at non-equatorial latitudes, heat pipe orientation can play a role heat pipe selection. The absorber header, which can be a constant conduction heat pipe, may operate in reflux and the downcomer heat pipe may be replaced with a simple thermosyphon, and an oscillating heat pipe downcomer can be taller which may affect conductance or drive a need to switch to loop heat pipes or force shorter absorbers. Thus, gimballed absorbers could be pursued to achieve 1 or 2 axis gimballing. Because of the minimal lunar seasons, 2-axis gimballing has no merit. In general, the unreliability of moving parts suggests that gimballing is not preferred. A single axis gimbal may be required for near-polar absorbers to track the sun. A metal flex hose oscillating heat pipe and/or flexible heat pipe can be used for gimballing of the absorber 120. An example flexible heat pipe is described in co-owned, co-pending U.S. Ser. No. 19/045,161 filed Feb. 4, 2025, entitled Flexible Heat Pipe, which is hereby incorporated herein by reference.

In embodiments of the system 100, some of the heat pipe components can be installed in steep selenographical features such as crater walls or cliffsides. In this manner, reduced liquid lift may be required out of the downcomer heat pipe 140, for example.

In embodiments of the system 100, hot water can be supplied as an option if the heat capacitor can deliver temperatures greater than 100° C. In this option, the human safe heat pipe 180 can attach to a water tank that can be insulated to provide up to 100° C. water. A second heat pipe, such as a variable conductance heat pipe, can ‘let the heat down’ from the up to 100° C. tank to, for example, a 50° C. tank (the temperature of typical home hot water) and then a regular human safe heat pipe can then be used to let down heat to the thermostatically controlled fan heat sink. In this example, three different ‘products’ are delivered to the system: water for cooking and cleaning, water for bathing, and warm air.

In embodiments of the system 100, a penetration free thermal interface, such as penetration free thermal interface 196 may be determined to be too low of performance (i.e. it is too heavy and/or takes up too much area on the habitation module 110 wall surface. In this determination, heat pipe penetrations can be accommodated. It is believed safer to permit the human safe heat pipe 180 to penetrate the habitation module 110 wall and extend to the outside the rather than to permit the variable conductance heat pipe 170 (with hazardous fluid) to penetrate inside the habitation module 110. In this optional system configuration, freeze protection heaters and/or insulation can be utilized on the human safe heat pipe 180 outside the habitation module 110.

In embodiments of the system 100, for lunar regolith with very low thermal conductivity, the required spacing between heat pipes to achieve an appropriate ‘time-to-access’ may become unrealistically small. In this case, fins can be incorporated on the heat pipes. These fins can be thin (possibly as thin as metal foil) sheets of thermally conductive metal. These fins can be thermally coupled to the heat pipes. Fins can either be assembled onto individual heat pipes or multiple heat pipes can pass through a single fin. If fins are required, this will tend to make the heat capacitor heat pipes stow less compactly and very careful handling can be required.

In embodiments of the system 100, the absorber 120 structure can comprise an isogrid or a solid plate panel or honeycomb panels.

In embodiments of the system 100, the heat capacitor, i.e., the regolith in which the network of heat capacitor heat pipes 150 is embedded, can be located under the habitation module 110. This permits heat leak out the bottom of the habitation module 110 and heat leak out the top of the heat capacitor to be mitigated.

In embodiments of the system 100, the components can be transportable and useful, for example, for use on lunar rover vehicles. By “transportable” is meant capable of being stowed and moved while in the field and then to be reassembled using field tools in a finite, operationally significant amount of time: i.e. no instantaneous setup. Flexible thermal links between heat pipes can be utilized for stowage, these can be either flexible heat pipes or flexible thermal straps.

In embodiments of the system 100, solar concentrator mirrors can be used, for example, to heat the solar energy system up to required temperatures. This may be needed in applications with low sun angles, cold air temperatures, and/or high product temperatures. In water heater systems, the water in the water heater acts as a heat capacitor to storage energy through the day/night cycle and possibly through a few cloudy days. A full capacity traditional heater system can also be utilized to deal with times involving weeks of low insolation. In such systems for providing warm air products, heat can potentially be stored in paraffin wax phase change material, although may involve a substantial mass, volume, and cost increase in the overall capability of the system. Alternatively, the system can eschew energy storage and only provide warm air at times when solar energy is available.

In embodiments of the system 100, any or all of the heat pipes can include safety burst disks and managed vent paths to allow the system to defuse dangerous over pressurization conditions.

Continuing to refer to FIG. 1, a heat-pipe based thermal control architecture for spacecraft 100 can also incorporate one or more loop heat pipe with a flash evaporator 134. Loop heat pipe flash evaporators are described in more detail in co-pending, co-owned U.S. Ser. No. 17/987,941 filed Nov. 16, 2022, entitled Loop Heat Pipe for Staged Reentry Spacecraft, which is hereby incorporated herein by reference. An example loop heat pipe with flash evaporator system 134 is shown in isolation for descriptive purposes in the schematic view of FIG. 7. The example loop heat pipe with flash evaporator system 134 includes a first fill/drain valve 140 at one end and a second fill/drain valve 142 at the opposite end of the loop heat pipe flash evaporator 134. A continuous loop heat pipe 144 forms a fluid conduit through which a heat transfer fluid traverses therethrough, but which is frangible to be interrupted, for example upon stage separation of the service module from the command module. A first heat exchanger 146 can be positioned proximate the first fill/drain valve 140. The first heat exchanger 146 can be a compensation chamber thermal radiator attached to a compensation chamber, and can function as a thermostat for a temperature thermal control system. A first squib valve 150 is normally open (NO) and can be connected to the loop heat pipe with flash evaporator system 134 below the first heat exchanger 146. The first squib valve 150 operates to prevent backflow through the loop heat pipe with flash evaporator system 134 when the first squib valve 150 is closed, e.g., post-separation of the service and command modules.

An example flexible heat pipe 236 is described in co-owned, co-pending U.S. Ser. No. 19/045,161 filed Feb. 4, 2025, entitled Flexible Heat Pipe, which is hereby incorporated herein by reference. Referring to FIG. 8 there is shown a representative flexible heat pipe 236. The flexible heat pipe 236 has an evaporator portion 244 and a condenser portion 246 separated by a flexible section 248. Heat 250 to be moved is transferred into the flexible heat pipe 236 in the evaporator portion 244 to cause a phase change in an internally disposed working fluid, e.g., vaporization to a gas phase, within the flexible heat pipe 236. Heat 252 to be released exits at the condenser portion 246 where the working fluid undergoes the reverse phase change, e.g., condensation back into a fluid. The fluid is then transported back, such as wicking by capillary transport, to the evaporator portion of the flexible heat pipe 236 to absorb additional heat. In the flexible heat pipe 236, the evaporator portion 244 and the condenser portion 246 can each be made of rigid metal and can include structural characteristics common to known rigid heat pipe configurations. In an example embodiment, the flexible heat pipe 236 can be generally cylindrically shaped and extend longitudinally about an imaginary central axis A.

As indicated in FIG. 8, and in the cross-section shown in FIG. 9, the flexible portion 248 of the flexible heat pipe 236 can be flexible and provide for the functional equivalent of axial ridges defining axial grooves in the interior 254 of the flexible heat pipe 236. In an embodiment, the flexible portion is a flexible metal pipe or hose (the terms being interchangeable and synonymous for this disclosure). As also shown in FIG. 8, the flexible portion 248 is a flexible metal hose with both radial corrugations 256 and axial corrugations 258. The radial corrugations 256 provide for bending flexibility of the flexible heat pipe 236. The axial corrugations 258 define the functional equivalent of the axial “ridge and groove” configuration of the evaporator and condenser portions described above. Internal corrugation peaks 260 define the functional equivalent of ridges that define internal valleys 262 that define the functional equivalent of grooves in the rigid portions of the flexible heat pipe 236. Capillary fluid transport indicated by the shading at 264 transports fluid from the condenser portion of the heat pipe to the evaporator portion.

Heat can be transferred from a human-safe heat pipe to one or more external (to the pressurized cabin) thermal radiators 230. In the example shown in FIG. 2, two radiators are shown, a first radiator 230A and a second radiator 230B. In an embodiment, one or more human-safe heat pipes can be in operative heat transfer arrangement with each thermal radiator. In an embodiment, each human-safe heat pipe can be in operative heat transfer arrangement with one or more thermal radiators. Thus, in an embodiment, metabolic and electronics human-safe heat pipes 224 can mounted to separate penetration free thermal interfaces which go to separate metabolic and electronic radiator thermal zones. As shown in the example embodiment of FIG. 2, the first human safe heat pipe 224A can be thermally coupled to the first radiator 230A via a flexible heat pipe 236 joined at a penetration-free thermal interface 232 permit thermal heat transfer across the interface to a thermostatic thermomodulating heat pipe, 238. A thermostatic thermomodulating heat pipe can be similar to a variable conductance heat pipe that is designed such that if the radiator temperature becomes warmer than the cabin temperature (such as due to flying in hot environments like across the sunlit moon in low lunar orbit), the gas in the thermostatic thermomodulating heat pipe can shift to the other side of the heat pipe and block heat transfer. In such a situation, heat can be shunted to radiators facing in cooler directions or store heat in the space vehicle or a phase change material.

Referring again to FIG. 2, the thermostatic thermomodulating conductance heat pipe 238 can utilize a reservoir 240 of non-condensable gas to dynamically adjust its heat transfer capability, allowing it to maintain a relatively constant temperature even when the heat load or sink conditions change significantly, as well as cold environment shutdown. The thermostatic thermomodulating conductance heat pipe 238 can operate similarly to a variable conductance heat pipe but is configured to be thermally coupled to interior heat pipes and external radiators to permit gas to move to a condenser in situations where the external radiator is hotter than the internal electronics and/or cabin environment. These capabilities render a thermostatic thermomodulating conductance heat pipe 238 useful in spacecraft thermal control systems due to its ability to adapt to varying heat loads in space environments. The thermostatic thermomodulating conductance heat pipes 238 can be thermally coupled to ammonia heat pipes 280, as described above, to spread heat across their respective radiators 230. In an embodiment, first radiator 230A can be a cool radiator zone, and second radiator 230B can be a warm radiator zone. For each, temperature and/or temperature changes and/or temperature differences can be monitored, detected, and/or controlled via a temperature gauge 282 for each internal to external heat pipe thermal flow path.

Referring to FIGS. 3 and 4, there is shown another example embodiment of a heat-pipe based thermal control architecture for a surface rover 300, which is described herein as a passive thermal system that includes heat transfer apparatuses and at least one surface rover 350 that can be transported inside a space vehicle 312. The surface rover 350 can have components common to surface rovers, including a plurality of wheels 352, each mounted to suitable suspension and power components 354 for powered mobility on surfaces. The surface rover 350 can have one or more hinged foldable components, such as camera probe 356 that can be folded about a hinged joint for compact stowage as depicted in FIG. 3 and deployed for use as depicted in FIG. 4. A heat-pipe based thermal control architecture for a surface rover 300 is described below, without duplication of the description of components that were described above.

A heat-pipe based thermal control architecture for a surface rover 300 can include one or more ammonia heat pipes 380 thermally coupled to heat sources, such as electronic equipment on the surface rover 300. The ammonia heat pipes can be thermally coupled to one or more rover-mounted thermostatic thermomodulating heat pipes 238. The thermostatic thermomodulating heat pipe 338 can utilize a reservoir 3 of non-condensable gas to dynamically adjust its heat transfer capability, allowing it to maintain a relatively constant temperature even when the heat load or sink conditions change significantly, as well as cold environment shutdown. The thermostatic thermomodulating heat pipe 338 can operate similarly to a variable conductance heat pipe but is configured to be thermally coupled to interior heat pipes and external radiators to permit gas to move to a condenser in situations where the external radiator is hotter than the internal electronics of the rover 312 The rover-mounted thermostatic thermomodulating heat pipe 338 can utilize a reservoir 340 of non-condensable gas to dynamically adjust its heat transfer capability, allowing it to maintain a relatively constant temperature even when the heat load or sink conditions change significantly, as well as cold environment shutdown.

As shown in FIG. 3, the ammonia heat pipe(s) 380 can also be thermally coupled to a frangible heat pipe 360 coupled to one or more space vehicle-mounted variable thermostatic thermomodulating pipes 370. The space vehicle-mounted thermostatic thermomodulating heat pipe 370 can utilize a reservoir 372 of non-condensable gas to dynamically adjust its heat transfer capability, allowing it to maintain a relatively constant temperature even when the heat load or sink conditions change significantly, as well as cold environment shutdown. One or more shape charges 356 can be positioned and configured to sever the rover heat pipes from the space vehicle heat pipes via the frangible heat pipe 360.

All of the embodiments of heat-pipe based thermal control architectures disclosed herein benefit from heat transfer and thermal stability via heat pipes with no moving solid parts. The reduction or elimination of moving solid parts increases reliability in use. Further, the various heat pipes disclosed can be modularly arranged in optimal heat transfer configuration utilizing passively pumped systems. For example, the flash evaporation components of the flash evaporation system 134 as shown in FIG. 1 can be mounted relatively higher (as viewed in the orientation of FIG. 1) than the human-safe heat pipes 124 to ensure heat flow is upward. In general, the various heat pipes of the disclosure can provide for steady state cooling on-orbit and transient when needed, such as during spacecraft reentry into earth's atmosphere. Further, the frangible heat pipe components permit transient mechanical operations, including staging of space flight components via shape charges that can sever portions of the heat pipe system. Still further, heat-pipe based thermal control architectures benefit by utilizing individual heat pipes as described, each optimally accomplishing a predetermined heat transfer function in its environment.

Having described the disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure. For example, any or all of the disclosed heat pipes can include overpressure relief for human safety.

All documents cited in the Detailed Description of the Disclosure are, in relevant part, incorporated herein by reference; the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A passive thermal control system for a lunar habitation module, comprising, an absorber, the absorber having a plurality of absorber heat pipes for gathering solar energy, the absorber being positioned above a lunar regolith;
a diode heat pipe thermally coupled to at least one of the plurality of absorber heat pipes;
a downcomer heat pipe thermally coupled to the diode heat pipe above the lunar regolith;
a network of heat capacitor heat pipes thermally coupled to the downcomer heat pipe below the lunar regolith;
a riser heat pipe thermally coupled to the network of capacitor heat pipes below the lunar regolith;
a variable conductance heat pipe thermally coupled to the riser heat pipe above the lunar regolith and thermally coupled to a penetration-free thermal interface on the outside of the lunar habitation module;
a human safe heat pipe thermally coupled to the penetration-free thermal interface on the inside of the lunar habitation module; and
a temperature regulation module operationally connected to the passive thermal control system to modulate heat transfer into the lunar habitation module.

2. The passive thermal control system of claim 1, wherein the plurality of absorber heat pipes are arranged in spaced, parallel relationship.

3. The passive thermal control system of claim 1, wherein the absorber comprises a plurality of absorber heat pipes comprising comprise titanium envelopes and use toluene fluid.

4. The passive thermal control system of claim 1, wherein the absorber comprises a plurality of absorber heat pipes configured in a rectangular-shaped pattern.

5. The passive thermal control system of claim 1, wherein the absorber comprises a sun-facing surface, and the sun-facing surface comprises a solar selective surface with black stripes.

6. The passive thermal control system of claim 1, wherein the downcomer heat pipe is an oscillating heat pipe.

7. The passive thermal control system of claim 1, wherein the heat capacitor heat pipes include a gas charge.

8. The passive thermal control system of claim 1, wherein the network of heat capacitor heat pipes has a Fourier number of from about 1 to about 3.

9. The passive thermal control system of claim 1, wherein the riser heat pipe is a thermosyphon.

10. A thermal control system, comprising,
an absorber, the absorber having a plurality of absorber heat pipes for gathering solar energy, the absorber being positioned above a lunar regolith;
a diode heat pipe thermally coupled to at least one of the plurality of absorber heat pipes;
a downcomer heat pipe thermally coupled to the diode heat pipe above the lunar regolith;
a network of heat capacitor heat pipes thermally coupled to the downcomer heat pipe below the lunar regolith;
a riser heat pipe thermally coupled to the network of capacitor heat pipes below the lunar regolith;
a variable conductance heat pipe thermally coupled to the riser heat pipe above the lunar regolith and thermally coupled to a penetration-free thermal interface on the outside of a lunar habitation module;
a human safe heat pipe with water as a fluid thermally coupled to the penetration-free thermal interface on the inside of the lunar habitation module;
a temperature regulation module operationally connected to the passive thermal control system to modulate heat transfer into the lunar habitation module; and
wherein the riser heat pipe and a portion of the variable conductance heat pipe are enclosed in insulation.

11. The thermal control system of claim 10, wherein the absorber comprises a solar selective surface.

12. The thermal control system of claim 10, wherein the diode heat pipe comprises a titanium envelope and toluene fluid.

13. The thermal control system of claim 10, wherein the diode heat pipe is a gas trap diode heat pipe.

14. The thermal control system of claim 10, wherein the absorber is disk-shaped, and the plurality of absorber heat pipes converge near the center of the disk-shaped absorber.

15. The thermal control system of claim 10, wherein the absorber is rectangular-shaped, and the plurality of absorber heat pipes are generally parallel and joined to a header heat pipe.

16. The thermal control system of claim 10, further comprising a header heat pipe thermally coupled to at least one of the plurality of absorber heat pipes and the diode heat pipe.

17. A thermal control system for a lunar habitation module, comprising,
an absorber, the absorber having a plurality of absorber heat pipes fixed in an orientation for gathering solar energy, the absorber being positioned above a lunar regolith;
a header heat pipe thermally coupled to at least one of the plurality of absorber heat pipes;
a diode heat pipe thermally coupled to the header heat pipe, the diode heat pipe being a Ti-toluene heat pipe oriented substantially orthogonally to a gravitational vector;
a downcomer heat pipe thermally coupled to the diode heat pipe above the lunar regolith;
a network of heat capacitor heat pipes thermally coupled to the downcomer heat pipe below the lunar regolith;
a riser heat pipe thermally coupled to the network of capacitor heat pipes below the lunar regolith;
a variable conductance heat pipe thermally coupled to the riser heat pipe above the lunar regolith and thermally coupled to a penetration-free thermal interface on the outside of the lunar habitation module;
a human safe heat pipe with water as a fluid thermally coupled to the penetration-free thermal interface on the inside of the lunar habitation module;
a temperature regulation module operationally connected to the passive thermal control system to modulate heat transfer into the lunar habitation module; and
wherein the riser heat pipe and a portion of the variable conductance heat pipe are enclosed in insulation.

18. The thermal control system of claim 17, wherein the absorber is substantially rectangular-shaped.

19. The thermal control system of claim 17, wherein the absorber comprises black painted stripes.

20. The thermal control system of claim 17, wherein the lunar regolith is a heat capacitor.
